(19) United States
(12) Patent Application Publication
(10) Pub. No.: US 2015/0065399 A1
(43) Pub. Date: Mar. 5, 2015

(54) Methods and Compositions for Enhanced Acid Stimulation of Carbonate and Sand Stone Formations

(71) Applicants: Ramesh Varadaraj, Bartlesville, OK (US); Cooper E. Haith, Bethlehem, PA (US); Barbara Carstensen, Annandale, NJ (US); Cornelius H. Brons, Easton, PA (US)

(72) Inventors: Ramesh Varadaraj, Bartlesville, OK (US); Cooper E. Haith, Bethlehem, PA (US); Barbara Carstensen, Annandale, NJ (US); Cornelius H. Brons, Easton, PA (US)

(21) Appl. No.: 14/330,974

(22) Filed: Jul. 14, 2014

Related U.S. Application Data
(60) Provisional application No. 61/870,651, filed on Aug. 27, 2013.

(51) Int. Cl. C09K 8/52; C09K 8/32; E21B 43/25; E21B 7/00; E21B 43/16; E21B 43/26

(52) U.S. Cl. CPC C09K 8/52; E21B 43/16; E21B 43/26; E21B 43/25; E21B 7/00; C09K 8/32
USPC 507/135; 166/244.1; 166/305.1; 175/57; 166/307; 166/308.1; 507/256

(57) ABSTRACT

An operations fluid is provided for treatment operations on wellbores associated with hydrocarbon production, the operations fluid comprising: water, an inorganic primary acid; and an alkyl acid surfactant. The alkyl acid surfactant has the general formula {R—X}, wherein R comprises at least one of linear and branched alkyl and alkyl aryl hydrocarbon chains and X comprises an acid, and X may comprise an acid selected from the group comprising sulfonic acids, carboxylic acids, phosphoric acids, and mixtures thereof. The alkyl acid may include an acid selected from the group consisting of alkyl or alkyl aryl acids. The operations fluid may be useful in treatment operations related to formation stimulation or mitigation of non-aqueous filter cakes (NAF) and/or formation invasion by NAF drilling fluids.

### CROSS REFERENCE TO RELATED APPLICATIONS

This application claims the benefit of U.S. Provisional No. 61/870,651, filed Aug. 27, 2013, the entirety of which is incorporated herein by reference for all purposes.

### FIELD

The present disclosure relates generally to enhanced acid stimulation of carbonate and sand stone reservoir formations. More particularly, the present disclosure relates to fluids and methods for enhancing acid stimulation of oil and gas bearing carbonate and sand stone subterranean formations.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

For the purposes of the present application, it will be understood that hydrocarbons refers to an organic compound that includes primarily, if not exclusively, the elements hydrogen and carbon. Examples of hydrocarbon-containing materials include any form of natural gas, oil, coal, and bitumen that can be used as a fuel or upgraded into a fuel. Hydrocarbons are commonly found in subsurface formations. As used herein, the term formation refers to a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state. A formation can refer to a single set of related geologic strata of a specific rock type, or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

Operators of hydrocarbon-related wells are engaged in a variety of activities designed to extract hydrocarbons or hydrocarbon-containing materials from a formation. A variety of wells and well types can be drilled into and a variety of operations can be conducted on a single formation in an effort to extract those hydrocarbons. The strategy for the wells and the operations depends on the formation's stage of development, the nature of the formation, and the nature of the hydrocarbon-containing materials in the reservoir associated with the formation, etc. For example, drilling operations may be required to create wellbores exploit hydrocarbon production potential from the formation. Additionally, the wells may be equipped and completed, such as by positioning one or more pieces of downhole equipment in the borehole (i.e., the space evacuated by the drilling operation within the wellbore, which refers to the formation face). The completion may include wellbore damage remediation and/or formation stimulation of mitigate production obstacles. Still additionally, formation fluids may be produced into the borehole and to the surface. In related operations, fluids may be injected into the formation from the borehole for a variety of reasons, such as to treat the near-well region of the formation, to drive formation fluids towards another well, to sequester fluids or gases, etc. Still additionally, stimulation fluids may be injected into the borehole to connect the well bore to the reservoir by forming wormholes, fractures, effective permeability pathways, etc., for the flow of formation fluids.

The art is ripe with methods and systems for stimulating formations and/or remediating formation drilling damage, using acids to dissolve reactive formation media, thereby creating pathways of improved impermeability. Acidizing techniques such as acid washes, matrix stimulation jobs, foamed acid stimulations, acid fracturing, propped fracturing using acids, etc., are all well known in the art, using a range of inorganic and organic acids. Common acids include acetic, citric, hydrochloric, hydrofluoric, formic, nitric, sulfuric, chloroacetic, and sulfuric. For example, HCl acid may be delivered into the formation in concentrations such as from 2 wt % to 35 wt %, commonly 15%. Targeted formations commonly include carbonate based formations, but sandstone formations and drilling fluid residue may also benefit from acid treatments.

There are multiple factors that may limit an operator's ability to stimulate a carbonate or a sand stone reservoir. One common factor is the presence of filter cake accumulated on the wellbore and/or downhole equipment in the borehole. Filter cake as used herein may refer to the residue deposited on a medium, which is frequently a permeable medium, when a slurry, such as a drilling fluid, is forced against the medium under a pressure. Filter cake properties, such as cake thickness, toughness, slickness, and permeability, are important because the cake that forms on permeable regions of the wellbore can be beneficial to an operation or may be detrimental to an operation. The problems that a filter cake may present include reduced permeability during production and/or stimulation operations. While filter cakes can present numerous challenges or disadvantages, operators also know that there are various advantages provided by filter cakes, such as limiting the loss of drilling fluid to the formation, reducing risks of contaminating or damaging a reservoir during drilling, retaining formation fluids during drilling to prevent kicks, etc. Accordingly, there has been a long history of publications and inventions directed to targeted creation and destruction of filter cakes.

Filter cakes may be formed from aqueous and non-aqueous slurries. The properties of the filter cakes and the available remediation methods may vary depending on the type of slurry used when the filter cake forms. For example, it is well known that filter cakes formed from a non-aqueous fluid (NAF), such as an oil-based or synthetic oil-based drilling mud, exhibit far less permeability than a filter cake formed from an aqueous fluid and are also more difficult to remediate. While the decreased permeability of NAF filter cakes may suggest using aqueous drilling fluids to avoid the NAF filter cake, some implementations require NAF drilling fluids for a variety of reasons, as is well known. The decreased permeability of a NAF filter cake, or filter cake formed from NAF slurries, has been observed to complicate the remediation of the filter cake, often necessitating complex treatment fluids. In some proposed solutions, the NAF filter cake is only treatable by using a coordinated system of drilling muds and treating fluids.

Exemplary teachings known in the art include the use of chelating agents to extract metallic weighting agents from filter cakes, the use of acidic treatment fluids to dissolve the filter cake elements, and/or the use of surfactants to clean the filter cake from the surface of the wellbore. One exemplary publication of such teaching may be found in U.S. Patent Publication No. 2008/0110621. Other exemplary related publications may be found in U.S. Patent Publication Nos. 2007/0029085 and 2008/0110618; and in U.S. Pat. Nos. 5,909,774; 6,631,764; 7,134,496; and in Single-phase Microemulsion Technology for Cleaning Oil or Synthetic-Based Mud; Lirio Quintero, et al; 2007 AADE National Technical Conference, Apr. 10-12, 2007.

U.S. Pat. No. 5,909,774A discloses fluid for enhanced acidization. The types of surfactants disclosed are: a) Non-ionic surfactants which are alkly ethoxylated alcohols b) sodium alkyl aryl sulfonates c) sodium alkly sulfates d) sodium dioctyl sulfosuccinate e) sodium alpha olefin sulfonate. The sulfonates are salts of alkali metals such as sodium or potassium.

U.S. Pat. No. 6,631,764B2 discloses use of Suitable pH modifying agents include mineral acids (such as hydrochloric acid), organic acids (such as formic acid, acetic acid, or citric acid), and chelating agents, in particular cationic salts of polyaminocarboxylic acids chelating agents suitable typically using at neutral or mild pH, ranging from 3.5 to 8.0.

US20070029085A1 discloses wettability modifiers include partially or completely fluorinated surfactants or polymers, for example fluorosilanes such as perfluorosilanes, urethane oligomers containing perfluoro alkyl moieties, fluoroacrylates, and fluoroalkyl containing terpolymers or their mixtures. Other examples include surfactants, for example viscoelastic surfactants such as cationic surfactants such as quaternary amines, and zwitterionic surfactants, such as betaines.

U.S. Pat. No. 7,134,496B2 discloses a microemulsion fluid for remediating a filter cake. The microemulsion fluid contains water, oil and surfactants. It is disclosed that surfactants suitable for creating the single phase microemulsions include nonionic, anionic, cationic and amphoteric surfactants and in particular, blends thereof. Co-solvents or co-surfactants such as alcohols are optional additives used in the microemulsion formulation. Suitable nonionic surfactants include alkyl polyglycosides, sorbitan esters, methyl glucoside esters, or alcohol ethoxylates.

Other proposed solutions have attempted to use chelating agents to remove metallic weighting agents from the filter cake, such as US20080110621A1. While these solutions provide some improvement or some level of remediation, the conventional approaches are costly and complex.

Accordingly, need exists for improved systems and methods for breaking or remediating NAF wellbore filter cake, particularly for the purpose of stimulation of hydrocarbon bearing reservoirs and injection or disposal wells.

### SUMMARY

The present disclosure overcomes the limitations of the known prior art by providing methods and systems for remediating or overcoming the permeability issues created by an NAF. The disclosed methods provide for use of an operations fluid containing water, an inorganic acid, and an alkyl acid surfactant for remediating a filter cake formed by use of an NAF in wellbore operations, typically drilling-related operations. The alkyl acids are not salts of alkali metal salts, however, the effectiveness of the subject alkyl acids to enhance acid stimulation effectiveness has been surprisingly impressive.

The alkyl acid surfactants of the instant invention are compatible with primary stimulation acids such as hydrochloric acid, hydrofluoric acid, sulfuric acid used in a stimulation of carbonate reservoirs. Further, the alkyl acids are compatible with the corrosion inhibitors and many other additives used with the hydrochloric acid, hydrofluoric acid, sulfuric acids. The compatibility is advantageous as it permits use of the alkyl acid surfactant either in a stimulation process stage prior or in conjunction with the primary acid stimulation. Such acid stimulations may be useful in either sedimentary or metamorphic reservoir rocks, such as a carbonate-based reservoir material.

The present disclosure is directed to fluids for use in remediation of filter cakes, particularly NAF filter cakes, and/or for stimulation of hydrocarbon bearing formations behind such filter cakes, such as oil and/or gas bearing carbonate and sand stone reservoir formations, and including methods and systems for using such operations fluids.

Exemplary fluids may be generally referred to herein as operations fluid and may comprise primary components such as water, inorganic acids and at least one surfactant. The inorganic acid may be referred to herein as the primary acid, such primary acid including inorganic acids such as but not limited to hydrochloric acid, hydrofluoric acid, and sulfuric acid. Other components may also be present within the operations fluid, referred to herein generally as secondary components, and may include any or all of a variety of customization components such as but not limited to corrosion inhibitors, sequestering agents, wetting agents, gelling agents, foaming agents, demulsifiers, stabilizers, etc.

The operations fluid may be adapted to perform as a treatment fluid for example, such as but not limited to use as a borehole face-wash, an operations pre-treatment fluid, damage remediation, and/or in stimulation operations. In some implementations, the operations fluid may be adapted to remediate a filter cake, such as a NAF filter cake. For example, the operations fluid may be adapted to remediate a filter cake by performing at least one of: 1) altering the wettability of a NAF filter cake from oil wetting to water wetting; and 2) extracting non-aqueous fluid associated with the NAF filter cake. The alkyl acid surfactants may be suitable for use in acid stimulation of carbonate and sand stone reservoir formations. In particular, the compositions may be useful when the well bore includes a NAF filter cake.

One exemplary method of utilizing the operations fluid may be in a method of stimulating a carbonate or sedimentary reservoir formation. Exemplary implementations include a method to enhance acid stimulation in a reservoir formation comprising: drilling into a formation with a non-aqueous fluid (NAF) to create a well bore; obtaining an operation fluid comprising water, an inorganic acid and at least one alkyl-acid containing surfactant; and pumping the operations fluid into the well bore. It may be desirable that at least a portion of the pumped operations fluid is pumped to contact the formation penetrated by the wellbore.

Optionally the fluid may be pumped into contact with a NAF filter cake within the wellbore, including the formation surrounding the wellbore. Optionally, the formation may be stimulated in conjunction with pumping the operations fluid into contact with the wellbore or the formation may be stimulated after the operations fluid contacts the wellbore. Optionally, a stimulation treatment may include at least one stage utilizing the operations fluid. Compositions, methods and systems may be provided herewith in accordance with various aspects of the improvements.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments described below. But rather, the invention includes all alternatives, modifications, and equivalents falling within the scope of the appended claims.

The operations fluid generally comprises primary components water, inorganic acid, and at least one surfactant comprising an acid component, preferably an alkyl-containing acid surfactant, such as an alkyl or alkyl aryl acid. The water component of the operations fluid may include substantially an aqueous material or solution, such as fresh, brackish, brine, and/or sea water.

The inorganic acid component of the operations fluid may be referred to herein as the primary acid to distinguish it from the acid component in the acid-containing surfactant. The primary acid includes one or more inorganic acids, such as but not limited to hydrochloric acid, hydrofluoric acid, sulfuric acid, and mixtures thereof. The primary acid may also include at least one of hydrochloric, hydrofluoric, formic, nitric, sulfuric, and mixtures thereof. The amount of primary acid in the operations fluid is typically in the range of 2 to 40 wt % of acid, based on the weight of the water used in the operations fluid. Other exemplary primary acid concentration ranges may include 5 to 40 wt %, 5 to 28 wt %, 5 to 20 wt %, 5 to 15 wt %, or 10 to 28 wt % or 10 to 20 wt %. Common exemplary prescribed acid concentrations include but are not limited to 15 wt %, 20 wt %, and 28 wt %. The acid is selected such that it is capable of reacting with the mud cake and/or reservoir formation, commonly at a desired reaction rate, to create worm holes and/or fractures from the well bore into the reservoir formation.

The at least one acid-containing surfactant primary component of the operations fluid may be an alkyl acid surfactant (or related acid comprising an alkyl functional group) having the general formula R—X. In this generalized formula, R may be selected from the group comprising linear and/or branched alkyl and/or alkyl aryl hydrocarbon chains of typically 8 to 24 carbon atoms. X may be an acid (referred to herein as the surfactant or secondary acid so as not to be confused with the primary inorganic acid component of the operations fluid system). An exemplary surfactant acid may be selected from the group comprising sulfonic acids, carboxylic acids, phosphoric acids, and mixtures thereof. In other aspects, the alkyl acid may comprise an acid selected from the group consisting of alkyl carboxylic acid, alkyl sulfonic acid, alkyl phosphoric acid, alkyl aromatic carboxylic acid, alkyl aromatic sulfonic acid, alkyl aromatic phosphoric acid, alkyl aryl carboxylic acid, alkyl aryl sulfonic acid, alkyl aryl phosphoric acid and mixtures thereof. The acid group is commonly attached to the alkyl group in the case of alkyl acid and attached to the aryl group in the case of alkyl aryl acid. For example, in dodecyl sulfonic acid the acid group is attached to the dodecyl alkyl group. Also for example, in dodecyl benzene sulfonic acid the acid group is attached to the benzene group.

R is an alkyl or alkyl aryl hydrocarbon chain. In some aspects, the aryl group of the alkyl aryl hydrocarbon is a 1-ring or 2-ring aromatic group. Often, the aryl group is a 1-ring aromatic group. Non-limiting examples of 1-ring aromatic groups are benzene, toluene and xylene. Non-limiting examples of an alkyl aromatic hydrocarbon chain are dodecyl benzene, decyl xylene, decyl benzene, decyl toluene and mixtures thereof. In some embodiments, X may be a sulfonic acid group.

The at least one surfactant may include a mixture of “alkyl acid”-containing surfactants. The surfactant components are preferably dissolved or dispersed in water. The total surfactant concentration may be in a range of from 0.1 wt % up to 20.0 wt %, based on the weight of water in the operations fluid. In other aspects, the total surfactant concentration may be in a range of from 0.5 wt % up to 10.0 wt %, based on the weight of water in the operations fluid. Typically, the total concentration of surfactant may be greater than about 0.1 wt % and less than about 10 wt %, and more preferably the total surfactant concentration may be greater than about 0.1 wt % and less than about 2 wt %.

The operations fluid including the alkyl acid surfactants may further comprise dissolved salts, such as but not limited to chloride and sulfate salts of calcium, magnesium, and potassium. The amount of dissolved salts, when included, may be in a range of from 0.01 wt % to 25 wt %, based on the weight of the water, or within a range of from 0.01 wt % to 5 wt %. The operations fluid may further comprise alcohols such as methanol, ethanol, propanol, butanol, pentanol, hexanol, heptanol, octanol and mixtures thereof. The alcohols, when included, may be included in a range of from 0.001 wt % to 15 wt %, based on the weight of water.

Other operations fluid components may also be present within the operations fluid system, such other components being referred to herein generally as secondary components. The secondary components may comprise substantially any compatible and useful additive, such as a variety of system customization components. Exemplary secondary components may include materials such as but not limited to corrosion inhibitors, inhibitor intensifiers, sequestering agents, wetting agents, gelling agents, foaming agents, emulsifiers, demulsifiers, stabilizers, mineral converting agents, proppants, salts, complexers, buffers, pH adjusters, solvents, alcohols, friction reducers, nitrogen, carbon dioxide, and/or combinations thereof. The system may also include crosslinkers, gelling agents, or thickening agents such as polymers, and/or diverting or blocking agents, such as rock salt or benzoic acid flakes, clay stabilizers and/or salts, such as potassium chloride, sodium chloride, magnesium chloride, and/or combinations thereof.

The subject operations fluid may be used in conjunction with substantially any operations use in constructing or preparing the wellbore, or in conjunction with using the wellbore as part of hydrocarbon production or injection operations. Exemplary operations may require adapting the operations fluid for use subsequent to wellbore exposure to a NAF, such as a treatment pill for use during drilling operations, such as to mitigate drill pipe sticking, or subsequent to drilling the wellbore such as during wellbore cleanup operations, or as part of the completion and/or stimulation operations. The operations fluid may be adapted for use during at least one of drilling operations, logging operations, casing operations, completion operations, cementing operations, stimulation operations, production operations, injection operations, or combinations thereof.

One exemplary method of utilizing the operations fluid is with a system or method of pre-treating or enhancing acid stimulation of a reservoir formation after the well bore has been drilled with a NAF drilling mud. Exemplary implementations may include a method to enhance acid stimulation in a reservoir formation comprising, drilling into through a geologic formation using a fluid that contains a non-aqueous fluid (NAF) to create a well bore; obtaining an operations fluid comprising water, an inorganic primary acid, and at least one acid-containing surfactant; pumping a volume of the operations fluid into the well bore that has the NAF filter cake, wherein the volume of operations fluid is pumped to contact the NAF filter cake. The operation may end there with removal of the filter cake or extended somewhat to also work on filter cake that has entered the damaged or altered zone near the wellbore face. The operation may still further be extended to include stimulating the reservoir formation using the operations fluid, such as with a matrix acid stimulation job and/or with an acid-fracturing operation. In still other instances, an operations fluid process that utilizes the subject operations fluid may be conducted in advance of or in conjunction with yet another stimulation operation, such as a further acid stimulation operation or a propped fracturing operation that may or may not include acid.

Using or pumping the operations fluid may broadly include any of a number of methods or applications to remove NAF filter cake damage, remediate near-wellbore formation alterations due to drilling, or to initiate formation stimulation operations. Other exemplary applications may include use of the operations fluid in operations such as jet washing the wellbore face with the operations fluid, spotting operations fluid across a formation or wellbore section, treating a damaged zone around the wellbore, matrix stimulation, mud removal in advance of a cement or gravel pack job, acid fracturing, and/or in conjunction with proppant fracturing. The operations fluid may be adapted for use to remediate a NAF filter cake by a mechanism that performs at least one of (1) altering the wettability of the NAF filter cake from oil wetting to water wetting, and/or (2) extracting non-aqueous fluid associated with the NAF filter cake.

In addition to the operations fluid disclosed herein, other improved aspects are disclosed providing for systems and methods of using the operations fluid. A treatment system is included that may be useful in operations on wells associated with hydrocarbon production, such as production wells, injection wells, and disposal wells. A wellbore or formation treatment system may comprise preparing an operations fluid, such as the operations fluid described and exemplified above. An exemplary system may include an operations fluid that comprises water, an inorganic primary acid, and an alkyl acid surfactant, and the operation fluid is placed into a wellbore. Placing the fluid into the wellbore may also include putting the operations fluid into contact with a wellbore face, such as in contact with a NAF drilling fluid and/or NAF filter cake, and/or within the near-wellbore invaded zone of the formation to mitigate formation permeability alterations due to the NAF fluid and related material.

Placing the operations fluid into the wellbore may also include introducing the fluid into the wellbore for purposes of moving the fluid into contact with the formation, such as a reservoir formation that may be associated with hydrocarbon production. For example, the operations fluid may be introduced into the formation as part of a formation matrix acid job, or as part of a formation hydraulic fracturing initiative that may use the operations fluid in conjunction with an inorganic acid and/or proppant materials.

Commonly, the step of placing the operations fluid into the wellbore comprises combining the water, the at least one inorganic acid, and the alkyl acid surfactant together as a “treatment pill” prior to placing the operations fluid into the wellbore. The term treatment pill generally refers to pumping a defined volume of the pre-prepared operations fluid into the wellbore in one step, for accomplishing a specific operational purpose. Preparing a treatment pill at the surface enables ensuring thorough and proper mixing and distribution of the combined materials with each other, resulting in improved quality control, as compared to downhole mixing of the operations fluid components. After preparing the operations fluid treatment pill, the pill may be spotted in the wellbore in contact with the NAF filter cake. Spotting may involve merely displacement and leaving the pill in contact with the NAF for a selected time duration, such as for at least 15 minutes, or up to one hour, or from between 5 minutes and one hour. The operations fluid also may be bullheaded into through the NAF, or displaced further into the near-wellbore altered zone invaded by the NAF drilling fluid. In other methods, the operations fluid may be applied using an energized stream and/or turbulent flow or circulation, to cause the operations fluid to physically wash, erode, or otherwise mechanically and chemically penetrate the NAF to remove the same from the wellbore face or formation.

The improved operations fluid may be incorporated into any of various methods for treating a geologic formation (including continuous sections, portions thereof, and multiple intervals) that are penetrated by a wellbore. An exemplary method may include the steps of preparing a treatment pill comprising: water; at least one inorganic acid; and an alkyl acid; placing the treatment pill into a wellbore; and disposing the treatment pill in contact with the formation penetrated by a wellbore. In addition to contacting an NAF filter cake along the wellbore face, the operations fluid may be incorporated into other methods such as disposing the treatment pill in contact with at least one of an open-hole section, a natural fracture zone, an operations-created fracture zone (such as created by stimulation treatment or by the drilling fluid during drilling operations), and/or along a cased or open hole section of the wellbore zone to be perforated, gravel packed, or cemented. In other methods or uses, the operations fluid is used wherein the NAF filter cake is formed on a wellbore wall in an un-cemented cased hole segment of the wellbore, and/or wherein the operations fluid is applied to the uncemented cased hole segment of the wellbore. In other instances, the operations fluid may be used in conjunction with a drilling operation that involves drill pipe in contact an NAF filter cake, wherein the operations fluid is used to mitigate drill pipe sticking in the NAF filter cake by introducing the operations fluid into contact with the NAF filter cake. Other methods utilizing the operations fluid may include a formation stimulation operation that includes or is preceded by an NAF filter cake treatment operation. The stimulation treatment operation may include, for example, at least one of matrix acidizing, acid fracturing, and/or a hydraulic fracturing or acid fracture stimulation treatment that includes proppant.

Formations treated by the operations fluid may also be used in operations associated with the production of hydrocarbons, such as production, injection, completion, and/or cuttings disposal operations. The treatment process using the operations fluid may result in improved hydrocarbon recovery, either from the treated wellbore or offset wells that benefit from operations in the treated well. Typical treatment volumes for the treatment pill may be from a few barrels to several thousand barrels, such as for example, from 1 to 2500 bbls. Also the operations fluid may be introduced into the wellbore in one treatment step or in multiple steps, such as by following a first treatment pill with another treatment pill. A fluid pad or stage separation fluid may or may not be provided between the pill stages.

### EXAMPLES

The effectiveness of stimulation depends on the ability of the injected fluid to break the NAF filter cake and contact the reservoir formation. The following non-limiting examples illustrate the effectiveness of the operations fluid of the instant invention to break or degrade a NAF filter cake and enhance acid stimulation in a laboratory experiment.

Filter Cake Preparation: A NAF filter cake was prepared using a NAF and filtering it through a limestone disk. An exemplary NAF mud composition according to the present disclosure was made from using a commercially popular and common emulsifying NAF drilling fluid system (a commonly prepared Oil-Based Drilling Fluid solution (OBDF) with a final mud weight of about 12.4 ppg (1486 kg/m³, 1.486 g/cm³). A dynamic high pressure high temperature unit was used for the filtration process, with a pressure differential 800 psig (5.516 MPa), temperature 200° F. (93° C.) and 750 rpm mixing.

Dispersion Test-1 (Operations fluid with surfactant): 2.5 gram of the NAF filter cake was placed in a jar and to it was added 25 mL of an operations fluid containing 15% HCl and 1 wt % of alkyl acid surfactant R—X wherein R=dodecyl benzene and X=sulfonic acid. The jar was placed in an oven at 80° C. for 30 minutes. After 30 minutes the jar was taken out and shaken by hand for 1 minute. The entire mass of 2.5 g of filter cake was observed to break and disperse.

Dispersion Test-2 (Comparative fluid without surfactant): 2.5 gram of the NAF filter cake was placed in a jar and to it was added 25 mL of 15% HCl solution without the alkyl acid surfactant. The jar was placed in an oven at 80° C. for 30 minutes. After 30 minutes the jar was taken out and shaken by hand for 1 minute. A “water-in-filter cake” material was observed to form and the entire 2.5 of NAF filter cake aggregates into a single mass. No dispersion of the filter cake was observed.

Injection Test-1 (Operations fluid with surfactant): 1 mL of the operations fluid containing 15% HCl and 1% of the alkyl acid surfactant {R—X} wherein R=dodecyl benzene and X=sulfonic acid was injected at a velocity of 0.71 m/s directly on the disk containing the filter cake. After 5 minutes, the NAF filter cake was scrapped off. The treated disk was analyzed using a Keyence™ digital topography microscope and the depth of etch created by the operations fluid determined. An etch depth of 650-750 microns was achieved.

Injection Test-2 (Comparative Fluid Without Surfactant): 1 mL of the operations fluid containing 15% HCl and no the alkyl acid surfactant was injected at a velocity of 0.71 m/s directly on the disk containing the filter cake. After 5 minutes, the NAF filter cake was scrapped off. The treated disk was analyzed using the Keyence™ digital topography microscope to determine the depth of an etch created by the acid in the comparative fluid. The limestone disk was determined not etched by the acid comparative fluid.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

In the present disclosure, several of the illustrative, non-exclusive examples of methods have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities, other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” may mean A alone, B alone, C alone, A and B together, A and C together, B and C together, A, B and C together, and optionally any of the above in combination with at least one other entity.

What is claimed is:

1. An operations fluid for use in operations on wells associated with hydrocarbon production, the operations fluid comprising:
water,
an inorganic primary acid;
an alkyl acid surfactant.

2. The operations fluid of claim 1, wherein said alkyl acid surfactant has the general formula {R—X}, wherein R comprises at least one of linear and branched alkyl and alkyl aryl hydrocarbon chains and X comprises an acid.

3. The operations fluid of claim 2, wherein X comprises an acid selected from the group comprising sulfonic acids, carboxylic acids, phosphoric acids, and mixtures thereof.

4. The operations fluid of claim 1 wherein said alkyl acid comprises an acid selected from the group consisting of alkyl carboxylic acid, alkyl sulfonic acid, alkyl phosphoric acid, alkyl aromatic carboxylic acid, alkyl aromatic sulfonic acid, alkyl aromatic phosphoric acid, alkyl aryl carboxylic acid, alkyl aryl sulfonic acid, alkyl aryl phosphoric acid and mixtures thereof.

5. The operations fluid of claim 2, wherein the aryl group of the alkyl aryl hydrocarbon chain comprises at least one of a 1-ring or 2-ring aromatic group.

6. The operations fluid of claim 5, wherein the aromatic group comprises at least one of benzene, toluene, and xylene.

7. The operations fluid of claim 2, wherein the aryl group comprises at least one of dodecyl benzene, decyl xylene, decyl benzene, dodecyl toluene, and mixtures thereof.

8. The operations fluid of claim 2, wherein X comprises a sulfonic acid group.

9. The operations fluid of claim 2, wherein said alkyl group of the alkyl acid surfactant comprises a carbon chain length in a range of from 8 to 24 carbon atoms.

10. The operations fluid of claim 1, wherein said alkyl acid surfactant is present in the operations fluid at a concentration in the range of 0.1 to 20 wt % based on the total weight of water in the operations fluid.

11. The operations fluid of claim 1, wherein said alkyl acid is present in the operations fluid at a concentration in the range of 0.5 to 10 wt % based on the total weight of water in the operations fluid.

12. The operations fluid of claim 1, wherein the inorganic acid comprises at least one of hydrochloric, hydrofluoric, formic, nitric, sulfuric, and mixtures thereof.

13. The operations fluid of claim 1, further comprising at least one of chloride and sulfate salts of at least one of calcium, magnesium, and potassium.

14. The operations fluid of claim 13, wherein the salt in the operations fluid is in a range of from 0.01 wt % to 25 wt %, based upon the weight of water in the operations fluid.

15. The operations fluid of claim 1, further comprising a hydrocarbon fluid produced from the wellbore following treatment with the operations fluid.

16. The operations fluid of claim 1, wherein the operations fluid is adapted for use during at least one of drilling operations, completion operations, logging operations, casing operations, cementing operations, stimulation operations, production operations, and injection operations.

17. The operations fluid of claim 1, wherein the operations fluid is adapted to remediate a non-aqueous fluid (NAF) filter cake by performing at least one of:
altering the wettability of the NAF filter cake from oil wetting to water wetting; and
extracting non-aqueous fluid associated with the NAF filter cake.

18. A treatment system for operations on wells associated with hydrocarbon production, the treatment system comprising:
preparing an operations fluid comprising:
water,
an inorganic primary acid;
an alkyl acid surfactant; and
placing the operations fluid into a wellbore associated with hydrocarbon production.

19. The treatment system of claim 18, further comprising placing the operations fluid into an invaded zone of the formation surrounding the wellbore.

20. The treatment system of claim 18, further comprising placing the operations fluid into the formation surrounding the wellbore.

21. The treatment system of claim 18, wherein the step of placing the operations fluid into the wellbore comprises placing the operations fluid into a wellbore that comprises at least one of an NAF mud and an NAF filter cake.

22. The treatment system of claim 18, wherein the step of placing the operations fluid into the wellbore comprises combining the water, the at least one inorganic acid, and the alkyl acid surfactant together as a treatment pill prior to placing the operations fluid into the wellbore.

23. The treatment system of claim 22, wherein the treatment pill is spotted in the wellbore in contact with an NAF filter cake.

24. A method for treating a formation penetrated by a wellbore comprising:
preparing a treatment pill comprising:
water;
at least one inorganic acid; and
an alkyl acid;
placing the treatment pill into a wellbore; and
disposing the treatment pill in contact with the formation penetrated by a wellbore.

25. The method of claim 24, further comprising disposing the treatment pill in contact with at least one of an open-hole section, a natural fracture zone, an operations-created fracture zone, and a zone to be perforated, gravel packed, or cemented.

26. The method of claim 24, further comprising thereafter producing hydrocarbons from the wellbore.

27. The method of claim 24, further comprising disposing another treatment pill comprising operations fluid within the wellbore in contact with a formation penetrated by the wellbore.

28. The method of claim 24, wherein the wellbore comprises at least one of an NAF invaded zone and an NAF filter cake.

29. The method of claim 24, wherein the treatment pill is spotted over a section of the wellbore for a period of at least fifteen minutes prior to displacing the spotted treatment pill.

30. The method of claim 24, wherein the treatment pill is substantially continuously circulated in contact with a section of the wellbore.

31. The method of claim 30, wherein the circulation introduces the operations fluid into the formation.

32. The method of claim 30, wherein the circulation introduces the operations fluid into the filter cake along a wall within the wellbore.

33. The method of claim 24, further comprising spotting the circulation fluid within a cased section of the wellbore prior to perforating.

34. The method of claim 24, wherein the method is performed substantially during at least one of drilling operations, completion operations, production operations, and injection operations.

35. The method of claim 24, wherein the NAF filter cake is formed on a wellbore wall in an un-cemented cased hole segment of the wellbore, and wherein the operations fluid is applied to the un-cemented cased hole segment of the wellbore.

36. The method of claim 24, further comprising performing a drilling operation using drill pipe within the wellbore while contacting a selected section of the wellbore with the operations fluid to mitigate drill pipe sticking in the wellbore.

37. The method of claim 24, further comprising allowing the operations fluid to contact the selected section of the wellbore for at least fifteen minutes.

38. The method of claim 24, further comprising thereafter stimulating the wellbore using at least one of matrix acidizing, acid fracturing, and proppant fracturing.
